(19) United States
(12) Patent Application Publication
(10) Pub. No.: US 2006/0095393 A1
(43) Pub. Date: May 4, 2006

(54) Pattern Build Software System

(76) Inventor: Christopher Mark Vinsant, Knoxville, TN (US)

Correspondence Address: Christopher Mark Vinsant, 10712 Deep Woods Ln, Knoxville, TN, 37934, US

(21) Appl. No.: 11/163,554

(22) Filed: Oct. 22, 2005

Related U.S. Application Data
(60) Provisional application No. 60/522,643, filed on Oct. 24, 2004.

(51) Int. Cl. G06F 17/00

(52) U.S. Cl. 706/45; 434/247

(57) ABSTRACT

The present invention is a software system and method whereby knowledgeable fishermen or hunters may effectively and affordably communicate their knowledge to others. The invention provides a way to capture relationships thought to exist between external determinates and the actions necessary to be successful while fishing or hunting. It further provides a way to build digital Patterns using this captured data, and offers an interface enabling fishermen or hunters to interact with the Pattern data. This interaction may occur on a personal computer, over the Internet, or through the use of such devices as handheld computers, smart phones, fish finders, as well as other onboard intelligent devices, and serves to aid and instruct the participant while fishing or hunting. The effect of such interaction closely mimics having an expert on location.

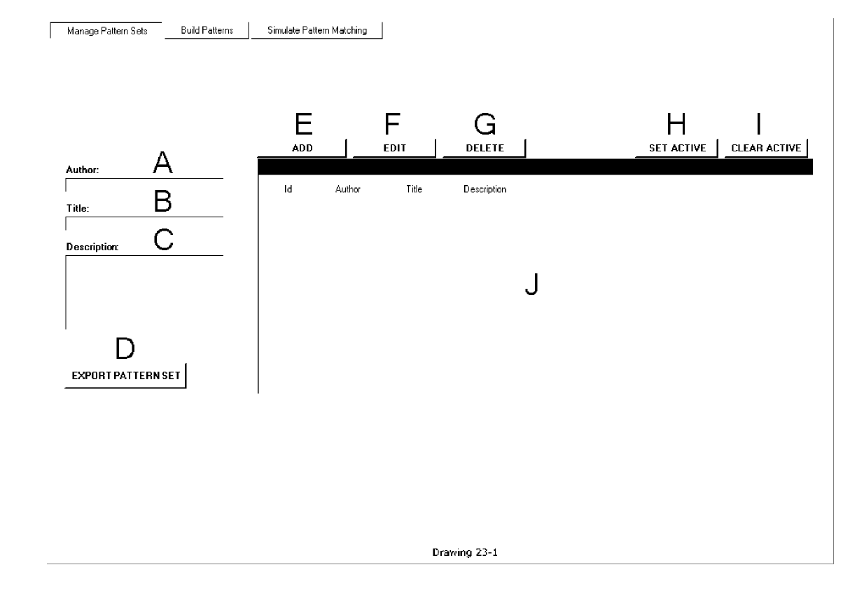

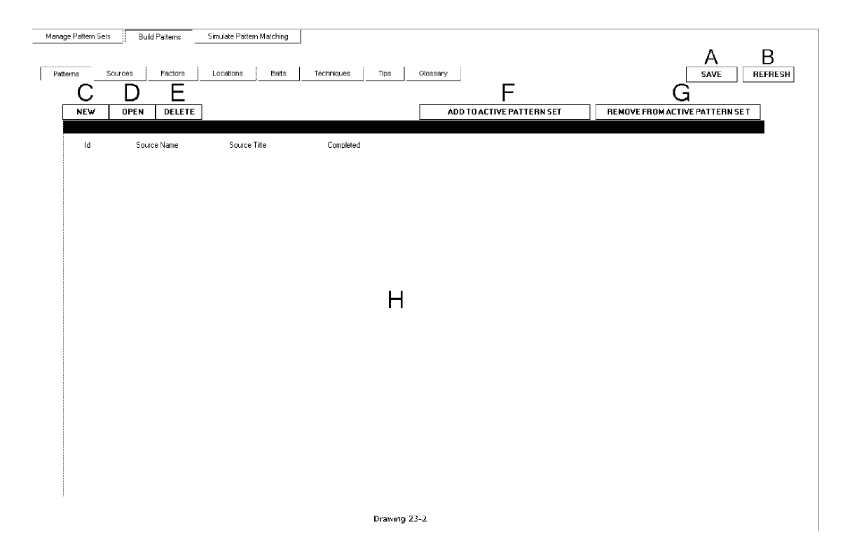

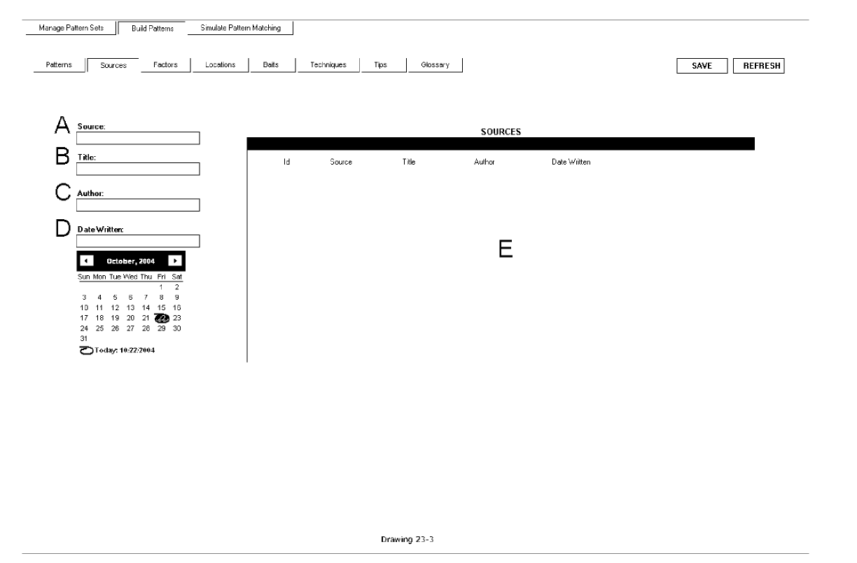

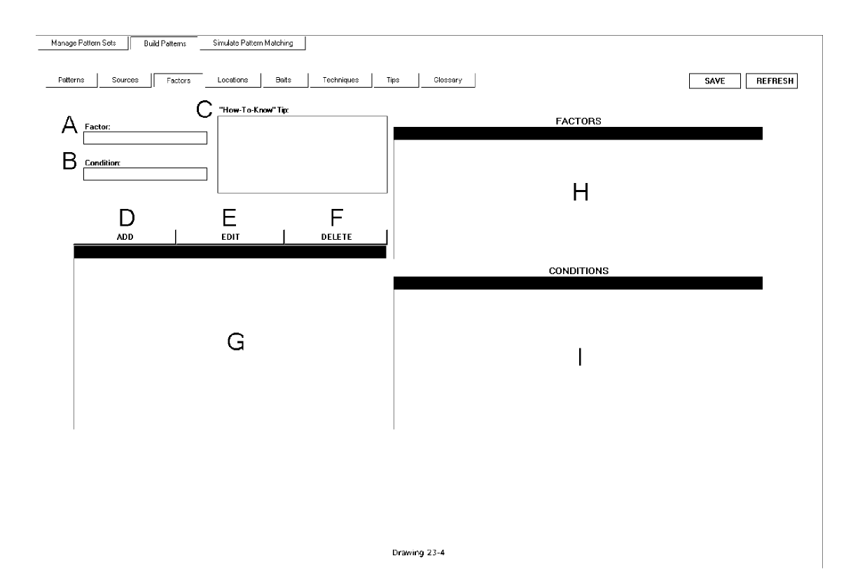

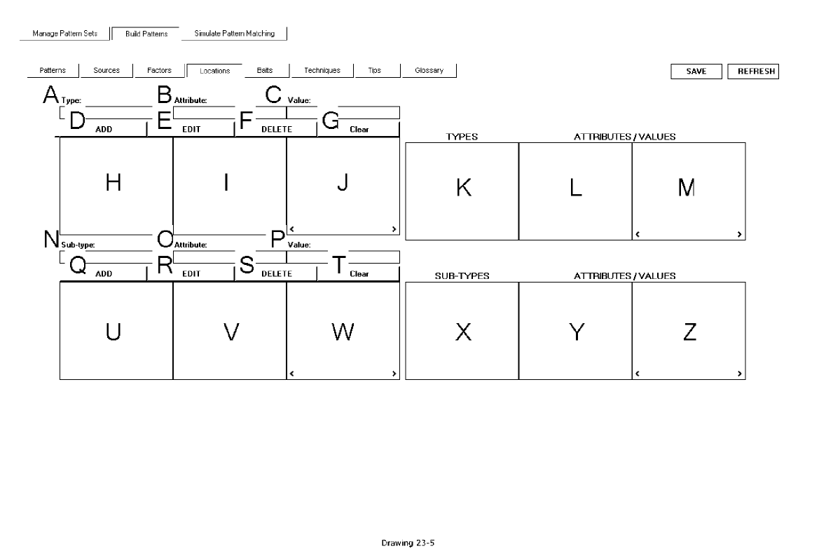

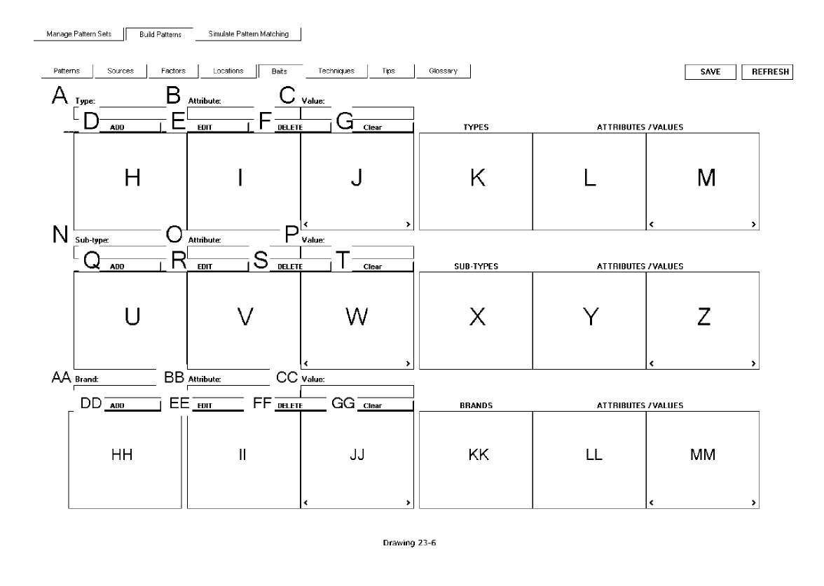

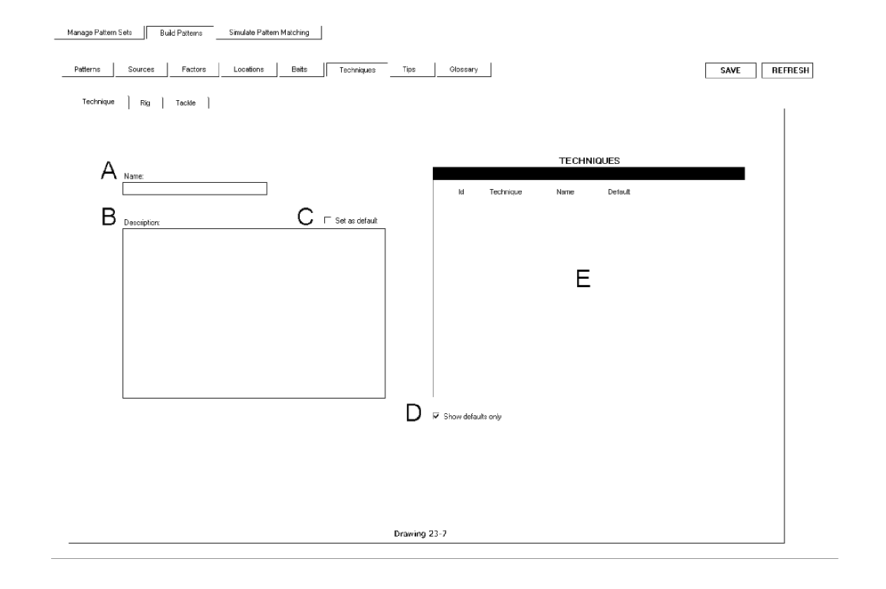

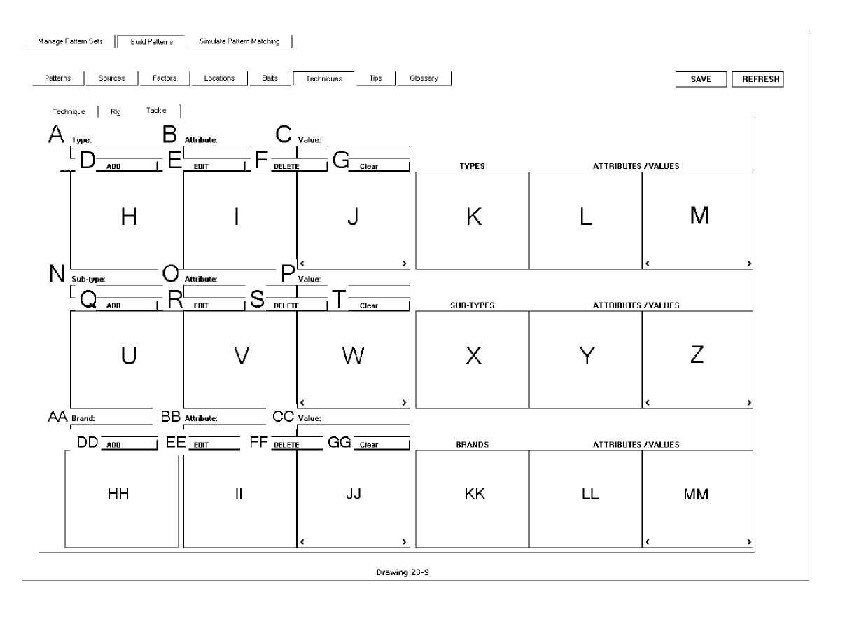

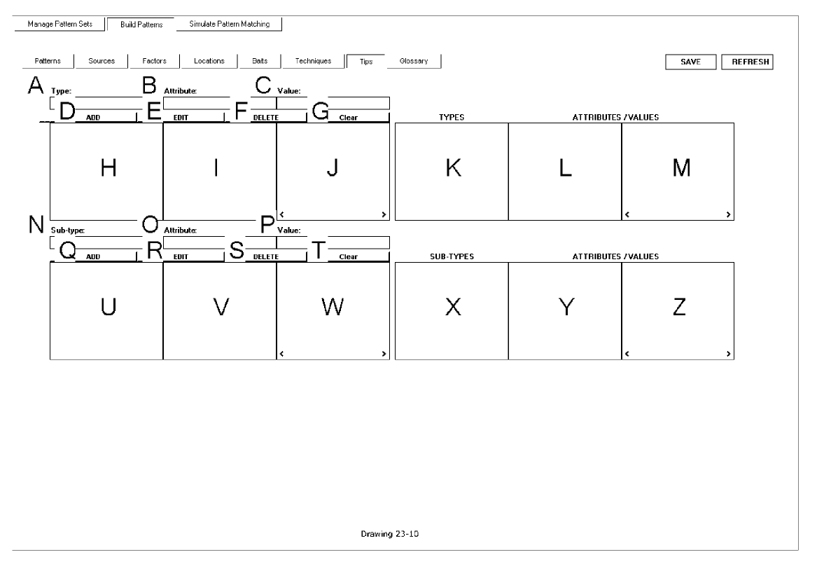

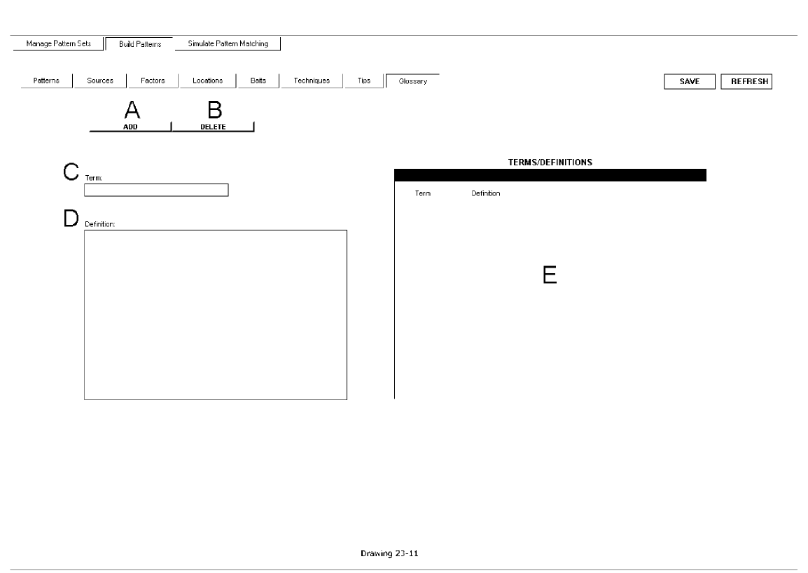

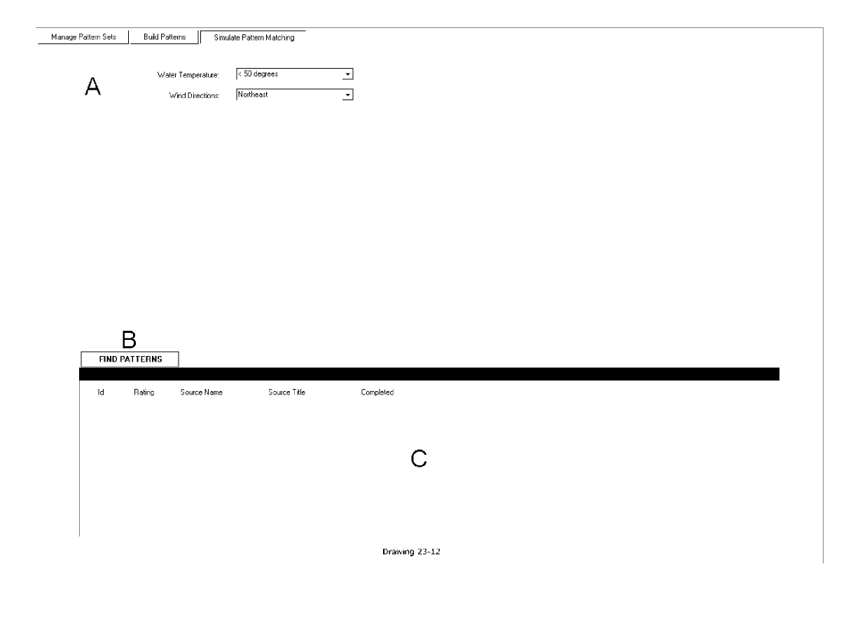

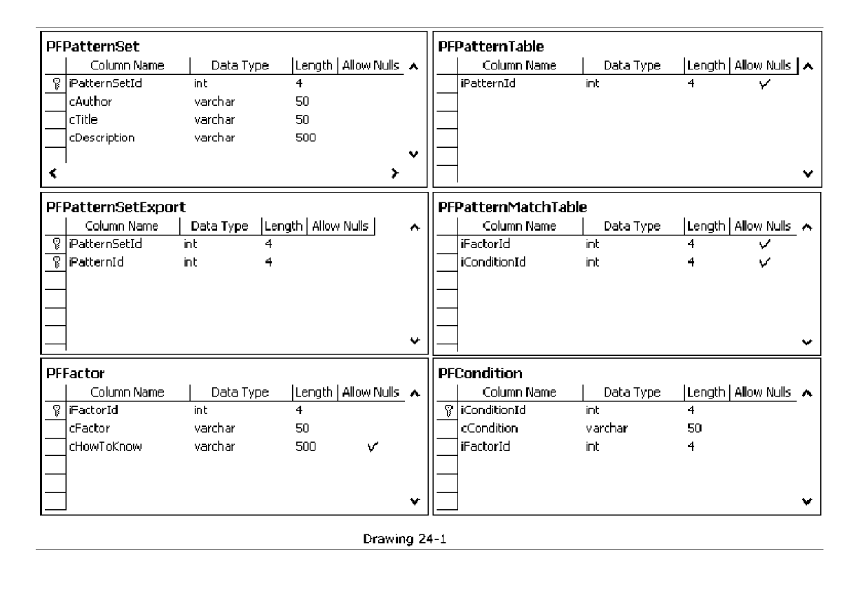

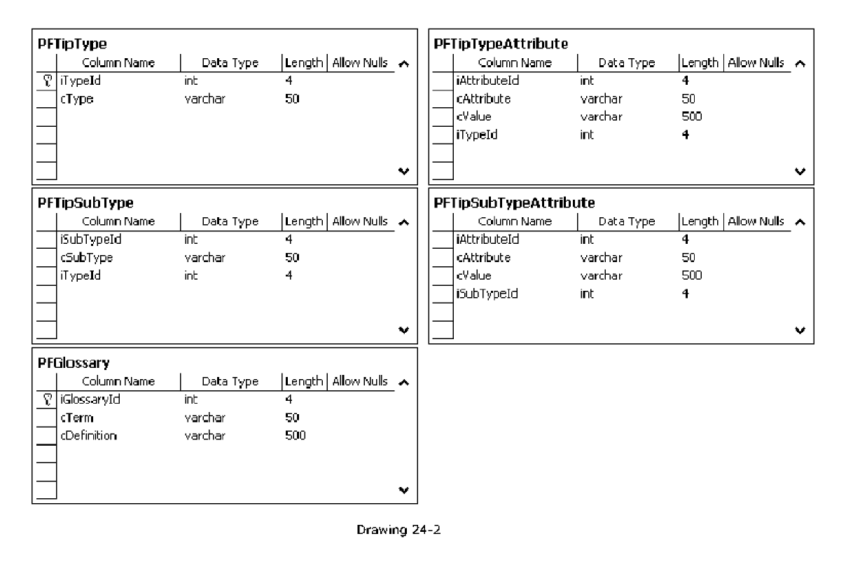

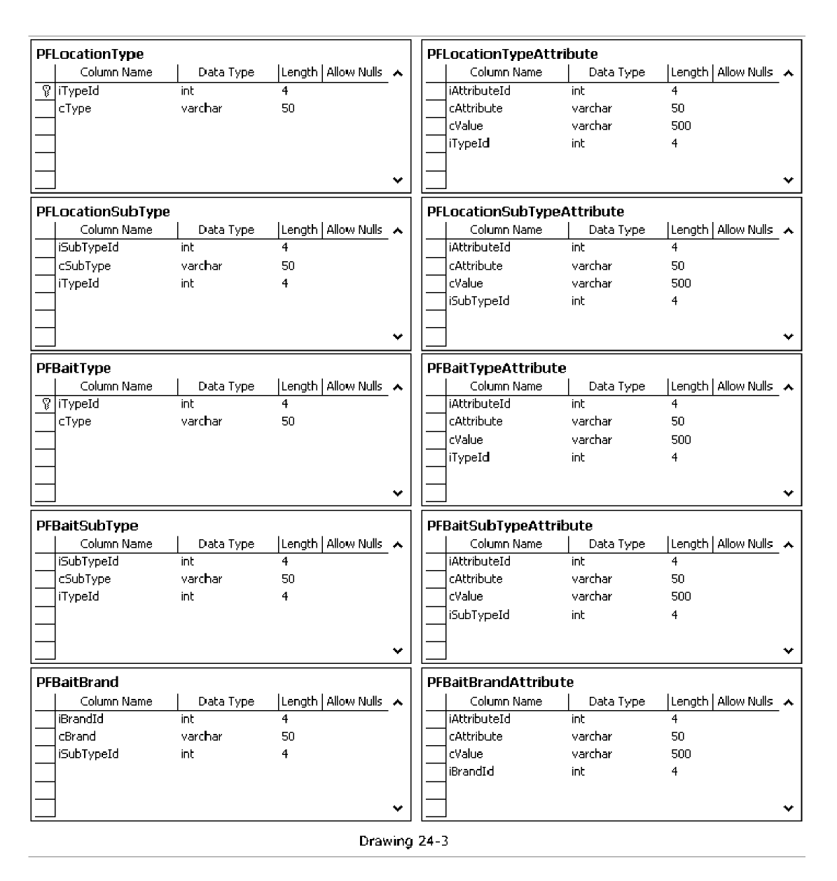

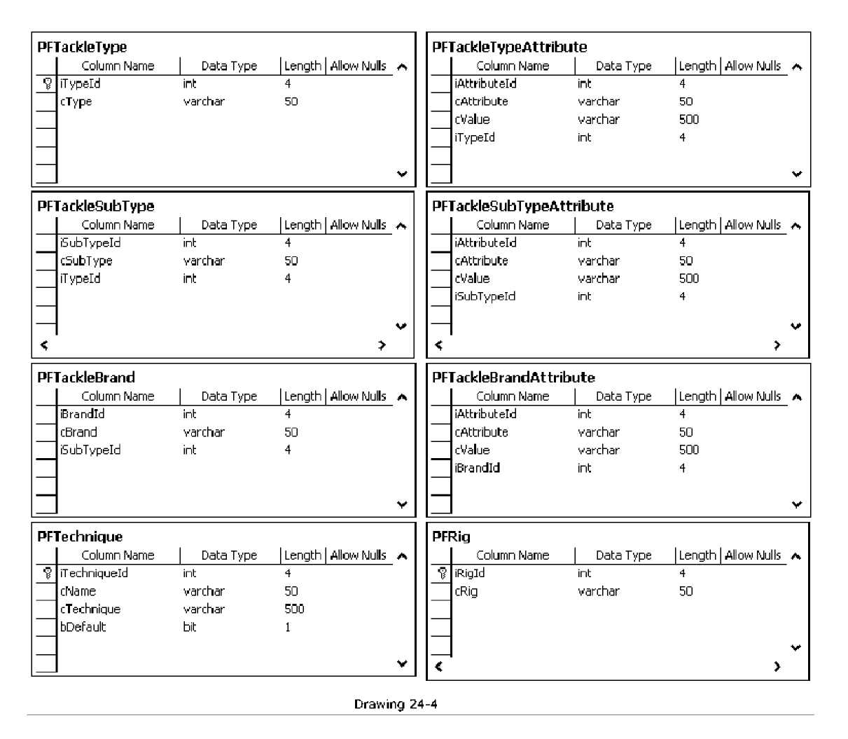

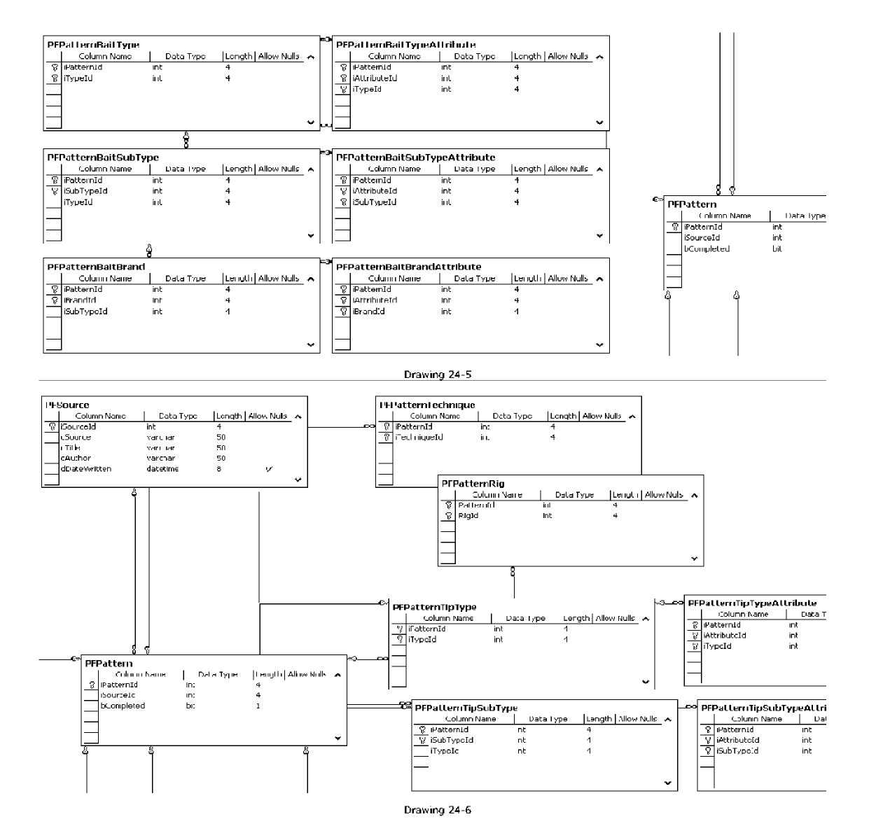

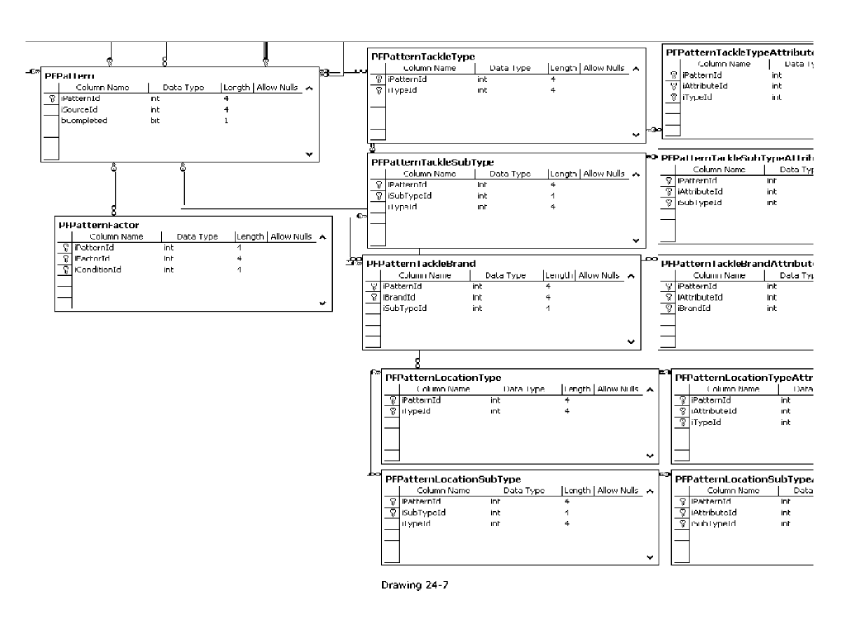

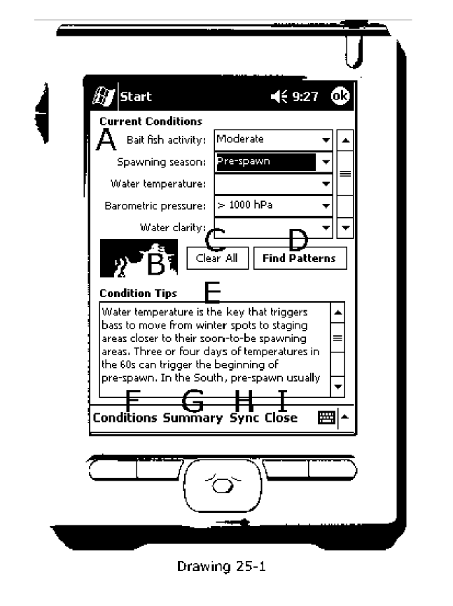

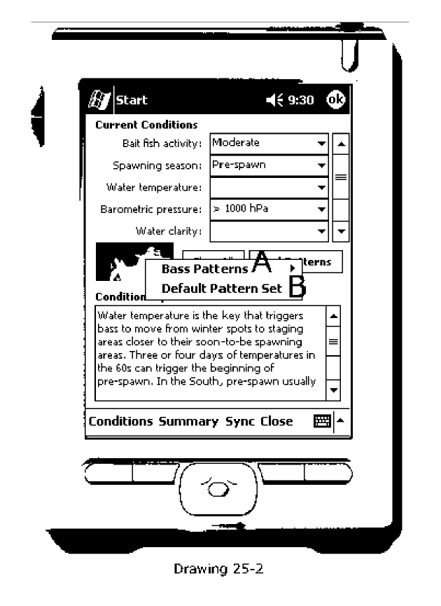

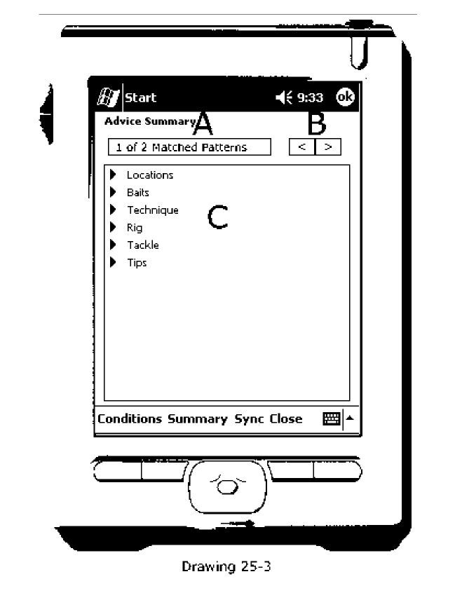

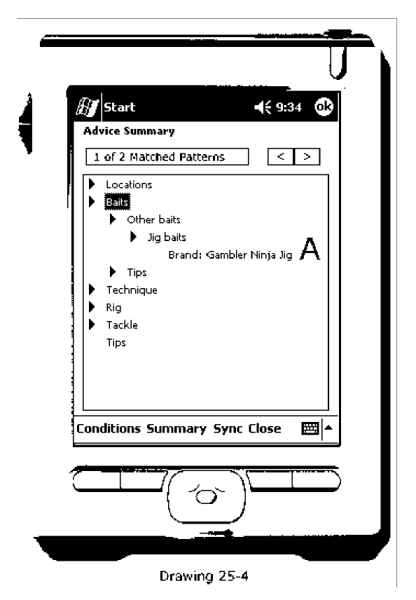

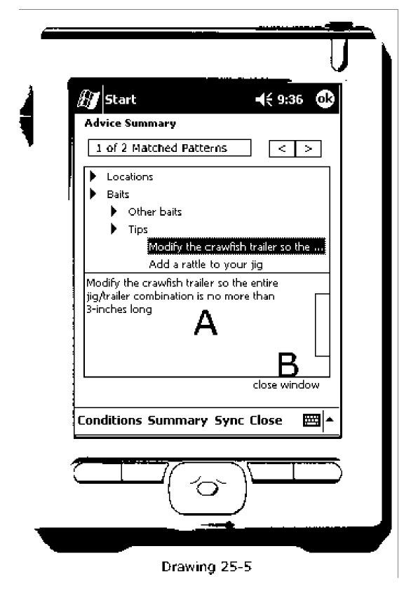

### FIELD OF INVENTION

The present invention relates to a software system providing a mechanism whereby knowledgeable fishermen or hunters are able to effectively and affordably share their knowledge with others to aid and instruct them so as to be more successful while fishing or hunting.

### BACKGROUND

It can be observed that, as with most endeavors, some excel at fishing or hunting more than others. In fact, entire industries have been established on this premise. For instance, fishing and hunting videos, radio and television programs, and magazines are dedicated to offering advice and commentary by those considered to be experts or of a professional rank among their peers. Many experts, while lesser known, provide personal guide services and maintain websites dedicated to sharing their insights into their respective sport.

But while much learning is and has been accomplished through such media channels, there are significant limitations to be sighted. For instance, while a fisherman may own stack upon stack of fishing magazines and may faithfully watch his favorite fishing program week after week, it is unrealistic to expect him to retain and recall all this information and to know how or when to apply such information in a given situation. In fact, it is more realistic that he would retain only a relatively small amount of the information he has processed and would from time to time incorrectly recall how or when to apply what he remembers.

Another limitation of learning through such media is that the learner must rely on his own ability to digest and associate the things being taught with his own real-world circumstances. For example, if an expert fisherman shares in an article how he caught bass on a certain lake in Wyoming, a fisherman in Tennessee who reads the article may conclude that he can catch bass in a Tennessee lake using the same tactics. However, the article may have included other factors such as the elevation of the lake, the mineral make-up of the water, or even the presence of an indigenous species of baitfish that was critical for success but was overlooked or forgotten by the Tennessee fisherman.

While prior art does exist that offers possible solutions for improving the catch rate of fishermen (or kill rate of hunters), none presently attempt to do so by providing a mechanism whereby knowledgeable fishermen (or hunters) can effectively affordably communicate their knowledge to help others.

U.S. Pat. No. 4,445,178 discloses a device that allows a fisherman to identify the current conditions of a fixed set of factors. For example, a fisherman may choose such things as current season (spring, summer, winter, or fall) and the time of day (early, mid-morn, mid-aft, or late). From this input, recommendations are provided to the fisherman for such things as bait type, bait size, and line size.

This solution takes into account a fixed number of factors with which to base its recommendations. Furthermore, the established relationships (i.e., “Patterns”) between those factors and the recommendations are fixed and assumed to be true irrespective of other conditions that may exist. Finally, this solution makes no attempt to use specialized knowledge of experts in the determination of its recommendations.

U.S. Pat. No. 6,222,449 discloses a system whereby information on fishing conditions at a remote location can be recorded and transmitted to a central location from which it may be accessed and shared by others.

This system is primarily concerned with the gathering of information relative to fishing conditions. However, the implied value of such data gathering is that by knowing the fishing conditions at a given location a fisherman can make better choices as to where to fish. Although the premise may be valid, the system again assumes to always know what data to gather (i.e., “identifiable factors”) and that the fisherman can reach the proper conclusions based on that data.

U.S. Pat. No. 6,587,740 discloses a system used to determine an angler rating. This rating is determined by compiling statistics on data entered into the system from various sources. This data consists of a myriad of elements based on actual fishing trip results.

This system makes no attempt to recommend to the fisherman how he might improve his fishing success. However, it is again seen that statistics based on historic data are the basis for the conclusion reached. While much useful information is recorded by this system, it is not the result or intent of the system to improve fishing catch rates using expert knowledge or experience.

U.S. Pat. No. 20,143,729 discloses a system capable of determining an individual's current geographic location. Based on this location, previously recorded geographic and topographic information is queried and analyzed, along with the individual's previously recorded skill level and/or limitations while performing a certain activity, and a recommended action is offered to the individual.

This system, predominately applied to the sport of golf, again bases its analysis and recommendations on historic data and not on expertise. The prior success or failure of the person engaged in the activity is also considered, but while this may be reasonable to consider for a golfer, it seems to be inconsequential when applied to a fisherman. Furthermore, the primary ingredient for determining a suggested action is geographic location. It seems unlikely that useful data would be available for every possible fishing location, but it is very likely that an expert fisherman could provide a set of consistent Patterns that could be successfully applied to many different geographic locations.

U.S. Pat. No. 30,195,787 discloses a system to provide real-time communication between an advice-seeker and an expert over a communications network.

This system, the only one presently known to seek the advice of an expert, requires that a live communication be established between the advice-seeker and the advice-provider. This poses a significant limitation on advice-seekers since there will undoubtedly be times and locations when such communication cannot be established due to unavailability of service. In addition, the cost-effectiveness of such a solution would likely prohibit a majority of fishermen from benefiting from such a system.

Accordingly, it is believed that a system providing a mechanism for knowledgeable fishermen and hunters to effectively and affordably share their knowledge with others is needed.

Definition List 1

| Term | Definition |
|---|---|
| Factor | A specific variable thought to affect the |
| | behavior of fish or animals. Examples |
| | include season, wind direction, and |
| | geographic region. |
| Condition | A specific value that may be associated |
| | with a factor. Examples include a factor |
| | of “season” and a condition of “fall”, a |
| | factor of “wind direction” and a condition |
| | of “northeast”, and a factor of |
| | “geographic region” and a condition of |
| | “southern”. |
| Pattern | A distinct set of data used to define a |
| | relationship thought to exist between (1) |
| | one or more factor/condition pairs and |
| | (2) specific actions, attitudes, behaviors, |
| | locations, baits, equipment, rigs, |
| | techniques, diagrams, or the like |
| | necessary to be successful while fishing |
| | or hunting. |
| Pattern Set | Any logical grouping of Patterns thought |
| | to be related in some way. |

### SUMMARY OF THE INVENTION

The preferred embodiment of the present invention is a software system providing:
(1) An interface to capture Pattern data originally supplied by a knowledgeable fisherman or hunter.
(2) Executable programming language statements capable of building the necessary relationships to construct and preserve Patterns and Pattern Sets into a long-term storage medium such as a database or file. Note that the resulting medium can and will be created in a form suitable for transport via Internet download, compact disc, digital memory card, e-mail attachment, and the like.
(3) A data structure sufficient to store and preserve such Patterns and Pattern Sets.
(4) One or more interfaces, both user or device interfaces, to allow retrieval of, input to, and interaction with such Patterns and Pattern Sets so as to allow the user to define his or her current conditions.
(5) Executable programming language statements capable of querying the content of the currently selected Pattern Set based on the current conditions as defined by the user or automated device inputs.
(6) One or more interfaces to display information to the user resulting from the queries issued against the Pattern data which were based on the currently defined conditions.
(7) Executable programming language statements capable of outputting and communicating to the user useful instructions and insights as dictated by the Pattern data.

The preferred interface referred to in Paragraph 17-1 is provided by either a desktop or web-based software application made available to knowledgeable fishermen or hunters, or a representative thereof, for the purpose of capturing Pattern data. The interface may consist of a series of panels or individual pages presented in a logical sequence to aid the user in transferring their knowledge of existing Patterns. Each panel or page may provide data input capabilities, guidance as to what data is to be entered or how it is to be entered, and options for saving the data thus far entered.

The preferred executable programming language statements referred to in Paragraph 17-2 would effectively support the transfer of knowledge necessary to capture Pattern data. Furthermore, they would effectively manage and accurately record the data as intended by the user.

The preferred data structure referred to in Paragraph 17-3 is that of a database consisting of numerous data tables related by primary and foreign keys. The structure would fully support both the storage and retrieval of Pattern data as needed by the interfaces referred to in Paragraph 17-1 and 17-4, respectively.

The preferred interface referred to in Paragraph 17-4 is provided by a software application executable from either a handheld device or other on-site computing device for the purpose of aiding and instructing the user. The interface may consist of various screens and screen elements to allow the user to interact with the Pattern data originally provided through the interface referred to in Paragraph 1 7-1.

The preferred executable programming language statements referred to in Paragraph 17-5 would effectively support the needed interaction between the user or external device and the Pattern data. Furthermore, they would effectively and accurately communicate the instructions and insights intended by the original provider of the Pattern data.

### SUMMARY OF THE DRAWINGS

Drawings (screenshots) related to Paragraph 17-1 in the “SUMMARY OF THE INVENTION”.

(1) Manage Pattern Sets

(2) Build Patterns—Patterns

(3) Build Patterns—Sources

(4) Build Patterns—Factors

(5) Build Patterns—Locations

(6) Build Patterns—Baits

(7) Build Patterns—Techniques—Technique

(8) Build Patterns—Techniques—Rig

(9) Build Patterns—Techniques—Tackle

(10) Build Patterns—Tips

(11) Build Patterns—Glossary

(12) Simulate Pattern Matching

Drawings (screenshots) related to Paragraph 17-3 in the “SUMMARY OF THE INVENTION”.

(1) Reference Tables Diagram—Part I.

(2) Reference Tables Diagram—Part II.

(3) Reference Tables Diagram—Part III.

(4) Reference Tables Diagram—Part IV.

(5) Pattern Build Tables Diagram—Part I.

(6) Pattern Build Tables Diagram—Part II.

(7) Pattern Build Tables Diagram—Part III.

Drawings (screenshots) related to Paragraph 17-4 in the “SUMMARY OF THE INVENTION”.

(1) Find Patterns

(2) Set Current Pattern Set

(3) Advice Summary

(4) Advice Summary—Expanded View

(5) Advice Summary—Extended View

### DETAILED DESCRIPTION OF THE INVENTION

The secret to success that sets apart those that excel at fishing or hunting from all the rest is their knowledge of existing Patterns. To illustrate, take the example of a professional bass fisherman. Since fishing is his livelihood, he must consistently catch fish no matter the time or place, no matter the conditions, and no matter his familiarity or unfamiliarity with the lake he finds himself on. The reason he is able to do this is in large part due to his knowledge of Patterns, those relationships he has found to exist between external determinates (such as water depth and barometric pressure) and all the things he must do in response to those determinates to catch fish. Therefore, the present invention to be detailed in the following narrative and illustrated by the accompanying drawings outlines a means whereby those Patterns may be effectively captured and shared with others to increase their success while fishing or hunting.

The first logical step in building a complete set of Patterns is to declare the author, title, and description of the Pattern Set. Drawing 23-1 represents that part of the interface used to create and manage Pattern Sets. Point A is used for assigning an author, point B for assigning a title, and point C for assigning a description. Point D is used to export the final product of the application, a relational database file, to a location designated by the user. This file can then be distributed through any number of distribution channels to those who would benefit from its contents. Points E, F, and G are used to add new Pattern Sets, edit, or delete existing ones. Points H and I are used to set or un-set the currently selected Pattern Set as the active one. This is to allow Patterns to be created independently of Pattern Sets. Finally, Point j is a display area used to view and select from all the available Pattern Sets that have been previously added through the interface.

The next logical step in building a complete set of Patterns is to begin building individual Patterns. The process of building individual Patterns involves the use of a series of panels. Drawing 23-2 represents that part of the interface (the first of eight sub-panels made available within the “Build Patterns” panel) used to create and manage Patterns. Points A and B are available on all eight of the sub-panels. Point A is used to save all the data currently defined for the Pattern being built. Point B is used to refresh the interface as underlying data changes that may affect the values currently being displayed to the user. Points C, D, and E are used to add new Patterns, edit, or delete existing Patterns. Points F and G are used to assign or un-assign the Pattern being built to the currently active Pattern Set. This allows Patterns to be created independently of Pattern Sets and can therefore be added to multiple Pattern Sets if desired. Finally, Point H is a display area used to view and select from all the available Patterns that have been previously added through the interface.

Continuing the Pattern build process, drawing 23-3 represents the second of eight sub-panels and is used to capture information related to the source of the Pattern data. Point A is used for assigning a source, Point B for assigning a title, Point C for assigning an author, and Point D for assigning a specific date the Pattern was first identified or made available to the public. It is necessary to allow each Pattern to have a unique author in the event several Pattern authors would decide to collaborate to create a single Pattern Set. Point E is a display area used to view and select from all the available sources. To illustrate the use of this panel, the source may be “In-Fisherman Magazine, March 2004”, the title may be an article titled “Why Bass Love the Fall”, the author is “John Smith”, and the date written is “Oct. 8, 2004”. In this illustration the source and title information are used to identify a previously written article in which the Pattern was first made known by the author.

Continuing the Pattern build process, drawing 23-4 represents the third of eight sub-panels and is used to capture information related to the factors and conditions Pattern data. This is the most critical aspect of the Pattern-building process. The relationships built in this panel define the exact circumstances necessary to exist in order that the remaining Pattern data may be successfully implemented. Point A is used for assigning a factor and Point B is used for assigning a condition. Point C is used for assigning a narrative to inform or instruct the Pattern user as to what the factor or condition is and how the factor or condition may be determined. For example, if the factor is “Spawning Period” and the condition is “Pre-Spawn”, the “How-To-Know” tip entered in Point C may be something such as “Water temperature is the key that triggers bass to move from winter spots to staging areas closer to their soon-to-be spawning areas. Three or four days of temperatures in the 60s can trigger the beginning of pre-spawn.” Points D, E, and F are used to add new factor/condition pairs, edit, or delete existing pairs. Point G is a display area used to view and select from all the available factor/condition pairs that are currently associated with the Pattern being built. Point H is a display area used to view and select from all the available factors that exists within any existing Pattern. This allows factors to be reused by many different Patterns. Finally, Point I is a display area used to view and select from all the available conditions that exists within any existing Pattern. This allows conditions to be reused by many different factor as well as Patterns.

Continuing the Pattern build process, drawing 23-5 represents the fourth of eight sub-panels and is used to capture information related to location Pattern data. Location data is typed and sub-typed in the interface using Points A and N. For example, a type of location may be “Structures” while a sub-type may be “Roadbeds”. Again, a type of location may be “Banks” while a sub-type may be “Main Lake”. Points B and C, O and P, allow certain attributes to be associated with types and sub-types, respectively. Continuing with our example, a type of “Banks” may have an attribute of “Bottom type” and a value of “Rocky”, while a sub-type of “Main Lake” may have an attribute on “Note” and a value of “High traffic areas are preferred”. It is very important to understand the flexibility available to the user with regard to typing and sub-typing as well as what attributes and attribute values are relevant for a given Pattern. With this approach, a user could provide actual GPS coordinates for the locations of a Pattern by simply adding an attribute of “GPS coordinate” and a value of “310.77”. Points D, E, and F allow the user to add, edit, or delete types, along with their attributes and values, to the Pattern being built. Point G is used to clear the values currently typed into the textboxes but not yet added to the Pattern. In a similar way, Points Q, R, and S allow the user to add, edit or delete sub-types, along with their attributes and values, to the Pattern being built. Point T is used to clear the values currently typed into the textboxes but not yet added to the Pattern. Points H, I, J, U, V, and W provide viewing areas for all previously entered location data for the Pattern being built. Finally, Points K, L, M, X, Y, and Z provide viewing areas for all existing location data across all Patterns previously entered. By providing such viewing areas, the user's productivity is increased since he may simply select from data previously entered and avoid re-entering the same information multiple times.

Continuing the Pattern build process, drawing 23-6 represents the fifth of eight sub-panels and is used to capture information related to bait Pattern data. Bait data, like the location data previously discussed, is typed and sub-typed in the interface using Points A and N. For example, a type of bait may be “Wire baits” while a sub-type may be “Spinner baits”. Again, a type of bait may be “Hard baits” while a sub-type may be “Crank baits”. In addition to types and sub-types, this interface provides a third level of detail for brands. Continuing with our example, a sub-type of “Crank baits” may have a brand of “Mann”, representing an actual market brand of crank bait. Points B and C, O and P, and BB and CC, allow certain attributes to be associated with types, sub-types, and brands, respectively. In our example, the Pattern author may choose not to assign attributes to the type “Wire baits”, while assigning a sub-type of “Spinner baits” having an attribute of “Color” and a value of “White”, and a brand of “Mann” having an attribute of “Style” and a value of “Gold Number 7”. Points D, E, and F allow the user to add, edit or delete types, along with their attributes and values, to the Pattern being built. Point G is used to clear the values currently typed into the textboxes but not yet added to the Pattern. In a similar way, Points Q, R, and S allow the user to add, edit or delete sub-types, along with their attributes and values, to the Pattern being built. Point T is used to clear the values currently typed into the textboxes but not yet added to the Pattern. In the same manner, Points DD, EE, and FF allow the user to add, edit or delete brands, along with their attributes and values, to the Pattern being built. Point GG is used to clear the values currently typed into the textboxes but not yet added to the Pattern. Points H, I, J, U, V, W, HH, II , and JJ provide viewing areas for all previously entered bait data for the Pattern being built. Finally, Points K, L, M, X, Y, Z, KK, LL, and MM provide viewing areas for all existing bait data across all Patterns previously entered.

Continuing the Pattern build process, drawing 23-10 represents the first of three sub-panels within the Techniques sub-panel, the sixth of eight sub-panels, which make up the main interface. This sub-panel is used to capture information related to technique Pattern data. Point A is used to assign a name to the technique, such as “Flipping” or “Trolling”. Point B is used to assign an exhaustive description of how one would successfully execute a “Flipping” or “Trolling” technique. Since many variations of the same basic technique may exist, Point C may be used to designate the primary technique within its many variations. Point D may be used to set a filter for the viewing area designated at Point E so that only primary techniques are shown. Finally, Point E provides a viewing area for all techniques.

Continuing the Pattern build process, drawing 23-8 represents the second of three sub-panels within the Techniques sub-panel, the sixth of eight sub-panels, which make up the main interface. This sub-panel is used to capture information related to rig Pattern data. Unlike techniques, rigs are not often known by common names. For this reason, this interface design does not allow the assignment of a name to a newly added rig. Point A is used to provide an exhaustive description of how the fisherman is to rig the tackle in order that a given technique may be executed properly. Point B may be used to set a filter for the viewing area designated at Point C so that only primary techniques are shown. Point C is a viewing area used to select a specific technique for which the rig will be used. Since multiple rigs may be defined for any given technique, Point D provides a viewing area for all previously entered rigs associated with the currently selected technique in the viewing area represented by Point C.

Continuing the Pattern build process, drawing 23-9 represents the last of three sub-panels within the Techniques sub-panel, the sixth of eight sub-panels, which make up the main interface. This sub-panel is used to capture information related to tackle Pattern data. Tackle data, like the location and bait data previously discussed, is typed and sub-typed in the interface using Points A and N. For example, a type of tackle may be “Weights” while a sub-type may be “Split shots”. Again, a type of tackle may be “Reels” while a sub-type may be “Spinning reels”. In addition to types and sub-types, this interface, like the location and bait data previously discussed, provides a third level of detail for brands. Continuing with our example, a sub-type of “Spinning reels” may have a brand of “Diawa”, representing an actual market brand of spinning reel. Points B and C, O and P, and BB and CC, allow certain attributes to be associated with types, sub-types, and brands, respectively. In our example, the Pattern author may choose not to assign attributes to the type “Reels”, while assigning a sub-type of “Spinning reels” having an attribute of “Spin Ratio” and a value of “5:1”, and a brand of “Diawa” having an attribute of “Model” and a value of “BG-13”. Points D, E, and F allow the user to add, edit or delete types, along with their attributes and values, to the Pattern being built. Point G is used to clear the values currently typed into the textboxes but not yet added to the Pattern. In a similar way, Points Q, R, and S allow the user to add, edit or delete sub-types, along with their attributes and values, to the Pattern being built. Point T is used to clear the values currently typed into the textboxes but not yet added to the Pattern. In the same manner, Points DD, EE, and FF allow the user to add, edit or delete brands, along with their attributes and values, to the Pattern being built. Point GG is used to clear the values currently typed into the textboxes but not yet added to the Pattern. Points H, I, J, U, V, W, HH, II, and JJ provide viewing areas for all previously entered tackle data for the Pattern being built. Finally, Points K, L, M, X, Y, Z, KK, LL, and MM provide viewing areas for all existing tackle data across all Patterns previously entered.

Continuing the Pattern build process, drawing 23-10 represents the seventh of eight sub-panels and is used to capture information related to tips Pattern data. Tips data, like the location, bait, and tackle data previously discussed, is typed and sub-typed in the interface using Points A and N. For example, a type of tip may be “Pre-Launch” while a sub-type may be “Equipment List”. Again, a type of tip may be “Tournament” while a sub-type may be “Rules”. Points B and C, O and P, allow certain attributes to be associated with types and sub-types, respectively. In our example, the Pattern author may choose not to assign attributes to the type “Tournament”, while assigning a sub-type of “Rules” having an attribute of “Creel limit” and a value of “7”. Points D, E, and F allow the user to add, edit or delete types, along with their attributes and values, to the Pattern being built. Point G is used to clear the values currently typed into the textboxes but not yet added to the Pattern. In a similar way, Points Q, R, and S allow the user to add, edit or delete sub-types, along with their attributes and values, to the Pattern being built. Point T is used to clear the values currently typed into the textboxes but not yet added to the Pattern. Points H, I, J, U, V, and W provide viewing areas for all previously entered tip data for the Pattern being built. Finally, Points K, L, M, X, Y, and Z provide viewing areas for all existing tip data across all Patterns previously entered.

Continuing the Pattern build process, drawing 23-11 represents a means whereby certain terms may be defined to help the fisherman understand terminology used with the Pattern data. Points A and B are used to add or delete glossary items. Point C is used to assign a term to be defined, and Point D is used to assign a definition to that term. Finally, Point E provides a viewing area for all existing glossary data across all Patterns previously entered.

As the final step in the Pattern build process, drawing 23-12 represents a means whereby the Pattern author may test the results of the relationships established between the factor/condition pairs and the remaining Pattern data. The importance of this panel is to insure the Pattern will be properly matched to the condition values selected. Point A presents dynamic labels and drop lists based on the content of all Patterns in the currently active Pattern Set. From these drop lists, the author may select the condition values entered for the Pattern being built to see what other Patterns may be matched and what rating is assigned to each. Point B allows the author to request that Patterns be found based on the condition values selected from the drop lists presented in Point A. Finally, Point C presents a viewing area of the matched Patterns. The rating column is used to communicate the level of match for each Pattern found. In an alternate design, such things as weights, which the author could be allowed to assign to the Pattern's factor/condition pairs, could affect this rating. This rating could also be presented to the fisherman to communicate what level of confidence is implied for a given matched Pattern.

Once a complete set of Patterns have been built and verified, the Pattern Set is ready to be distributed, installed, and used by others. Drawing 25-1 represents the first of two main screens of the interface used to view and interact with a Pattern Set. Point A represents that part of the interface that allows the user to identify to the system his current conditions by selecting values from drop-lists. (Note that these value selections could be made automatically through receiving input from one or more electronic devices responsible for measuring the current conditions and transferring those measurements back to a central processor.) The labels for each drop-list are built from all the factors previously defined for each Pattern in the Pattern Set, while the drop-lists themselves are populated using all the conditions previously defined for each of the factors. This is the most critical part of the interface in that it provides dynamic content based on the Pattern data contained in the Pattern Set currently in use. To illustrate, suppose a different author builds a new Pattern Set. When this Pattern Set is opened by the interface, Point A would be populated with different factors having different conditions from which to choose. This is possible due to the data structure implementation as well as the programming logic employed to retrieve the Pattern data. Point B is used to identify to the user what Pattern Set is currently in use, as there can be many Pattern Sets installed simultaneously. Point C is used to clear all the drop-list selections and to return the screen settings to their initial values. Point D is used to request the system to match the drop-list selections to the Patterns available in the current Pattern Set. Point E is used to display tips associated with certain conditions. This is necessary to help the user make the best drop-list selections. Points F, G, H, and I are menu selections available at all times to the user. Points F and G provide navigation between the two main screens of the interface. Point H is used to request the system to synchronize the Pattern Set with any updates or additions made available at a remote location. Finally, Point I is used to close the interface and therefore exit the application.

Drawing 25-2 represents a context menu providing the user a means to change the currently selected Pattern Set. Point A is used to select a desired Pattern Set from a list of installed Pattern Sets. The installed Pattern Sets may be categorized by species of fish or animal, by geographic region, alphabetically by author, etc. Point B is used to set a default Pattern Set.

Drawing 25-3 represents the second of two main screens of the interface used to view and interact with a Pattern Set. Point A designates the resulting number of Patterns found based on the information selected by the user in the screen represented by drawing 25-1. Point B is used to navigate between multiple matched Patterns when present. Finally, Point C presents the Pattern data related to the currently selected matched Pattern, categorized in the same manner by which the Pattern was built using the Pattern build component earlier described. This screen represents the end result of the entire Pattern build process. Drawings 25-4 and 25-5 represent the user's interaction with the Pattern data as nodes are expanded and selected to read and be instructed by the Pattern data as intended by the original Pattern author.

What is claimed is:

1. A method of effectively and affordably sharing expert knowledge with others, said method comprising the steps of:
executing computer programming statements;
capturing said knowledge by means of one or more graphical user interfaces;
storing said knowledge into a digital data store such as a database or file;
making said data store content available for use by others;
dynamically formatting one or more graphical user interfaces based on the content of said data store;
performing manual or automated searching, filtering, and summarizing of said content; dynamically formatting one or more graphical user interfaces based on the selected content resulting from said searching, filtering, and summarizing.

2. The method of claim 1, wherein the step of capturing said knowledge comprise the steps of:
entering data to define those factors and related conditions relevant to the current Patterns and Pattern Set being built;
entering data to define those specific actions, attitudes, behaviors, locations, baits, equipment, rigs, techniques, diagrams, and the like relevant to the current Patterns and Pattern Set being built;
defining the relationship between said factors and related conditions and said actions, attitudes, behaviors, locations, baits, equipment, rigs, techniques, diagrams, and the like.

3. The method of claim 1, wherein the step of dynamically formatting one or more graphical user interfaces based on the content of said data store comprise the steps of:
querying the said data store content to determine all the factors and related conditions contained therein;
displaying said factors and related conditions in one or more graphical user interfaces.

4. The method of claim 1, wherein the step of performing manual or automated searching, filtering, and summarizing of said content comprise the steps of:
selecting the actual, perceived, or assumed conditions, consistent with the conditions defined for the current Pattern Set, that represent the current on-site conditions.

5. The method of claim 1, wherein the step of dynamically formatting one or more graphical user interfaces based on the selected content resulting from said searching, filtering, and summarizing of that content comprise the steps of:
querying the said data store to determine those actions, attitudes, behaviors, locations, baits, equipment, rigs, techniques, diagrams, and the like that are related to the current conditions as selected;
displaying said actions, attitudes, behaviors, locations, baits, equipment, rigs, techniques, diagrams, and the like in one or more graphical user interfaces for the purpose of informing and instructing the user.
